(19) United States
(12) Patent Application Publication
(10) Pub. No.: US 2025/0391008 A1
(43) Pub. Date: Dec. 25, 2025

(54) REAL-TIME QUALITY INSPECTION METHOD AND APPARATUS

(71) Applicant: SK On Co., Ltd., Seoul (KR)

(72) Inventors: Dong Hyun LEE, Daejeon (KR); Hyo Sung HONG, Daejeon (KR)

(21) Appl. No.: 19/055,527

(22) Filed: Feb. 18, 2025

(30) Foreign Application Priority Data
Jun. 25, 2024 (KR) 10-2024-0082799

(51) Int. Cl. G06T 7/00; G06T 5/50; G06V 10/774

(52) U.S. Cl. CPC G06T 7/0004; G06T 5/50; G06V 10/774; G06V 2201/06

(57) ABSTRACT

A real-time quality inspection method and apparatus are disclosed, the method including photographing, by a camera, a target object in a manufacturing process to acquire plural images; receiving, by an inspection server, the plural images and arranging the plural images into a two-dimensional matrix to generate a merged image; and inputting, by the inspection server, the merged image into a quality inspection model to evaluate a quality of the target object based on result data output by the quality inspection model, wherein the quality inspection model is an artificial intelligence model that is learned to receive an image in which the plural images are merged and output result data indicating the quality of the target object appearing in the merged image, thereby performing real-time inspection for the target object manufactured through a high-speed process.

### CROSS REFERENCE TO RELATED APPLICATION

The present application claims priority to Korean Patent Application No. 10-2024-0082799, filed Jun. 25, 2024, the entire contents of which is incorporated herein for all purposes by this reference.

### TECHNICAL FIELD

The present disclosure relates to a real-time quality inspection method and apparatus that is capable of real-time inspection of the quality for a target object manufactured through a high-speed process.

### BACKGROUND

In the manufacturing field, the production volume per hour or the production volume per minute is an important factor in the production of products, which is associated with the tact time of the process time or manufacturing time.

In particular, due to industrial advancement, there is a continuous demand for reduction in manufacturing time, and accordingly, high-speed process performance is required.

In the battery manufacturing process, roll-to-roll transfer works of electrode materials and electrodes during the electrode process, slurry coating works, laser welding works during the assembly process, etc. are performed in high-speed processes.

### SUMMARY

Accordingly, an objective of the present disclosure is to provide a real-time quality inspection method and apparatus, which is capable of real-time inspection of the quality for a target object manufactured through a high-speed process.

The real-time quality inspection method and apparatus according to an aspect of the present disclosure may be widely applied to a manufacturing process of a secondary cell battery used in electric vehicles, battery charging stations, and green technology fields such as solar power generation and wind power generation using batteries.

The real-time quality inspection method and apparatus according to an aspect of the present disclosure may be applied to a manufacturing process of a secondary cell battery used in eco-friendly electric vehicles, hybrid vehicles, etc. to prevent climate change by suppressing air pollution and greenhouse gas emissions.

According to an aspect of the present disclosure, a real-time quality inspection method includes photographing, by a camera, a target object in a manufacturing process to acquire plural images; receiving, by an inspection server, the plural images and arranging the plural images into a two-dimensional matrix to generate a merged image; and inputting, by the inspection server, the merged image into a quality inspection model to evaluate a quality of the target object based on result data output by the quality inspection model, wherein the quality inspection model may be an artificial intelligence model that is learned to input an image in which the plural images are merged and output result data indicating the quality of the target object appearing in the merged image.

According to an embodiment, the acquiring of the plural images may include acquiring any plural images from: plural images that are continuously taken in real time by the camera to photograph a molten pool generated during a welding process of the target object to indicate changes in the molten pool; plural images that are continuously photographed in real time by the camera during a roll-to-roll transfer process of the target object to indicate surface cracks or foreign matter attachment generated in the target object in the transfer process; and plural images that are continuously photographed in real time by the camera to capture coating slurry generated during a process of coating the target object to indicate changes in the coating slurry.

According to an embodiment, the two-dimensional matrix may have a number of horizontal images and a number of vertical images determined so that a ratio of a horizontal size to a vertical size of the merged image is 1 or close to 1.

According to an embodiment, the generating of the merged image may include performing a sequential generation operation of generating the merged image when a number of plural images received in real time from the camera by the inspection server reaches a number of images included in the merged image, or a simultaneous generation operation of generating multiple merged images when plural images received in real time from the camera for a single target object are all received.

According to an embodiment, the generating of the merged image may include generating the merged image by adding dummy images as many as insufficient number when a number of plural images received in real time from the camera is insufficient to generate the merged image.

According to an embodiment, the evaluating of the quality of the target object may include: inputting, by the inspection server, the image merged into the quality inspection model; outputting, by the inspection server, the result data indicating the quality of the target object based on information learned by the quality inspection model; and determining, by the inspection server, the quality of the target object based on the result data.

According to an embodiment, the real-time quality inspection method further includes generating a learning data set that includes learning data including the merged image obtained by arranging the plural images of a target object photographed in a manufacturing process into a two-dimensional matrix, and label data including data indicating the quality of the target object; and inputting the learning data into an artificial intelligence model and comparing result data output by the artificial intelligence model with the label data, to optimize a weight of the artificial intelligence model and generate the quality inspection model.

According to an embodiment, the generating of the learning data set may include generating the learning data including the merged image by arranging the plural images of the target object photographed in the manufacturing process into a two-dimensional matrix; and generating merged label data by arranging the data indicating the quality of the target object given to each of the plural images of the target object photographed in the manufacturing process into the same two-dimensional matrix as the merged image.

According to an embodiment, the generating of the learning data may include merging the photographed plural images of the target object by arranging them into a two-dimensional matrix of “m×n” and generating a total of “K” merged images merged into an “m×n” array.

According to an embodiment, the generating of the learning data may include generating the merged image by including dummy images in a random number and location in the plural images of the target object photographed in the manufacturing process, and the generating of the label data may include generating the merged label data by positioning dummy data not associated with the data indicating the quality at a location corresponding to the dummy images included in the merged image.

According to an embodiment, the generating of the quality inspection model may include inputting the learning data into an artificial intelligence model, comparing result data output by the artificial intelligence model with the label data, and performing learning to adjust a function of the artificial intelligence model to create a base quality inspection model; and optimizing the base quality inspection model using a lightweight engine to generate a lightweight quality inspection model.

According to an aspect of the present disclosure, a real-time quality inspection apparatus includes a camera obtaining plural images by photographing a target object in a manufacturing process; and an inspection server receiving the plural images from the camera and inspecting a quality by analyzing the plural images, wherein the inspection server comprises an image receiving unit receiving the plural images from the camera; an image merging unit arranging the plural images into a two-dimensional matrix to generate a merged image; and a quality inspection unit inputting the merged image into a quality inspection model to evaluate a quality of the target object based on result data output by the quality inspection model; and wherein the quality inspection model may be an artificial intelligence model which is learned to receive an image into which the plural images are merged and output result data indicating the quality of the target object appearing in the merged image.

According to an embodiment, the inspection server further may include a learning data set generation unit generating a learning data set that includes learning data including a merged image generated by arranging the plural images of the target object photographed in the manufacturing process into a two-dimensional matrix, and label data including data indicating the quality of the target object; a model generation unit inputting the learning data into an artificial intelligence model, comparing result data output by the artificial intelligence model with the label data, and generating the quality inspection model by optimizing a weight of the artificial intelligence model; and a model lightweight unit reducing a capacity of the quality inspection model.

According to an embodiment, the camera may satisfy a performance of 250 to 300,000 Fame Per Second (FPS), and the target object may be an object having a moving speed range of 100 mm to 100,000 mm per second based on a moving distance, or a result produced by the object.

The features and advantages of the present disclosure will become more apparent from the following detailed description based on the attached drawings.

The terms or words used in this specification and claims should not be interpreted in their usual and dictionary meanings, but should be interpreted in their meanings and concepts that conform to the technical idea of the present disclosure based on the principle that the inventor may appropriately define the concept of the term to explain his or her own disclosure in the best way.

According to an embodiment of the present disclosure, the quality may be inspected in real time for a target object manufactured through a high-speed process.

According to an embodiment of the present disclosure, the quality may be inspected even in intermediate processes for a target object manufactured through a high-speed process.

According to an embodiment of the present disclosure, the time for quality inspection of a target object may be reduced.

According to an embodiment of the present disclosure, a large number of images may be processed.

According to an embodiment of the present disclosure, the quality inspection of a target object is performed through image merging processing, so that the memory usage of a graphics processing unit (GPU) in an inspection server may be reduced and power consumption may be reduced.

According to one embodiment of the present disclosure, it is possible to analyze the change trend of a target object by a high-speed process.

### BRIEF DESCRIPTION OF THE DRAWINGS

FIG. 1 is a diagram showing the configuration of an apparatus used in a real-time quality inspection method, according to an embodiment.

FIG. 2 is a diagram showing a real-time quality inspection method, according to an embodiment.

FIG. 3 is a diagram including an example of generating a merged image in a real-time quality inspection method, according to an embodiment.

FIG. 4 is a detailed diagram showing a quality evaluation step in a real-time quality inspection method, according to an embodiment.

FIG. 5 is a diagram showing a real-time quality inspection method which further includes a learning data set creation step and a quality inspection model creation step, according to an embodiment.

FIG. 6 is a detailed diagram showing a learning data set creation step in a real-time quality inspection method, according to an embodiment.

FIG. 7 is a diagram showing an example of generating learning data and label data in a real-time quality inspection method, according to an embodiment.

FIG. 8 is a diagram showing an example in which a dummy image is used for learning data having a merged image and dummy data is used for merged label data in a real-time quality inspection method, according to an embodiment.

FIG. 9 is a detailed diagram showing a quality inspection model creation step in a real-time quality inspection method, according to an embodiment.

FIG. 10 is a detailed configuration diagram showing an inspection server in a real-time quality inspection apparatus, according to an embodiment.

### DETAILED DESCRIPTION

Hereinafter, the present disclosure will be described in detail (with reference to the attached drawings). However, the present disclosure is merely exemplary and not limited to the specific embodiments described as exemplary.

The drawings may be shown to be schematic or exaggerated for the purpose of illustrating the embodiments.

Herein, the expression “may include” or the like indicates the presence of the feature (e.g., component such as a numerical value, function, operation, or a part), and does not exclude the presence of additional features.

Hereinafter, an embodiment of the present disclosure will be described in detail with reference to the attached drawings.

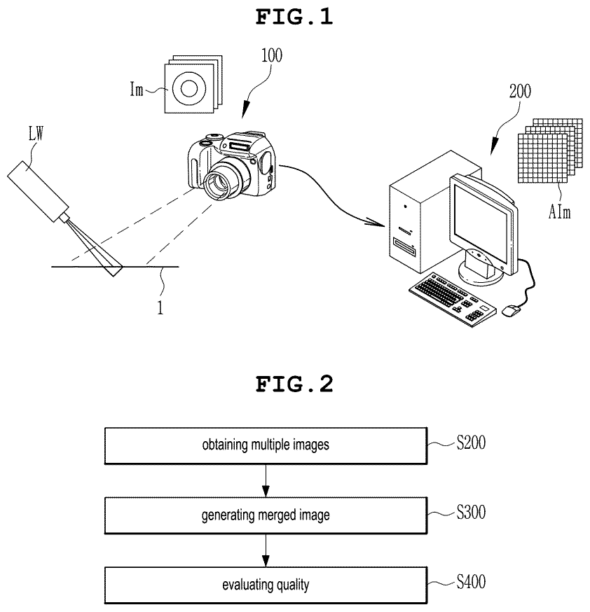

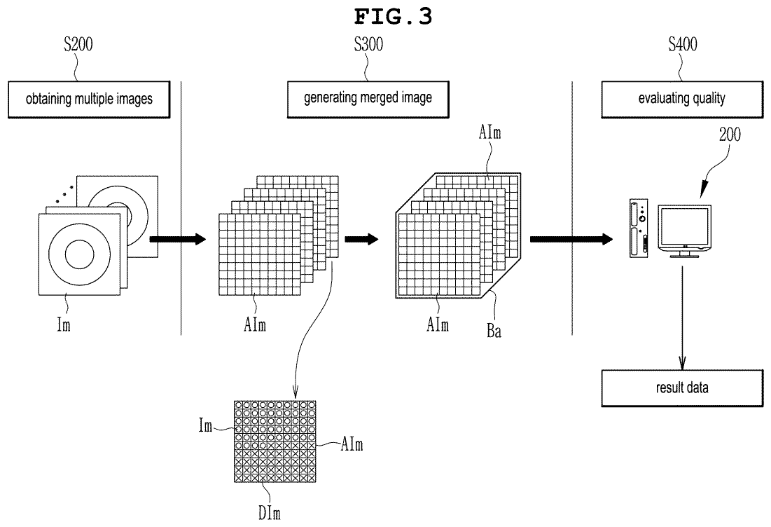

FIG. 1 is a diagram showing the configuration of an apparatus used in a real-time quality inspection method, according to an embodiment, FIG. 2 is a diagram showing a real-time quality inspection method, according to an embodiment, and FIG. 3 is a diagram including an example of generating a merged image in a real-time quality inspection method, according to an embodiment.

Referring to FIG. 1, the real-time quality inspection method according to the present disclosure may be implemented by a camera 100 that photographs a target object 1 to obtain plural images Im, and an inspection server 200 that receives the plural images Im from the camera to analyze the plural images Im and inspect the quality thereof.

The target object 1 may be an object whose manufacturing procedure is performed in a high-speed process in a wide range of industrial fields, or a result produced by the object.

The high-speed process may correspond to a battery manufacturing process in the case of the battery industry. Specifically, the target object may be a result formed by the moving speed of a laser welder in a welding process of a battery assembly process, in which the moving speed of the laser welder may be 100 mm per second or more. In addition, the high-speed process may include a roll-to-roll transfer of an electrode or electrode material during a battery electrode process, in which the moving speed of the target object using a roller may be approximately 100 m per minute.

The target object 1 may be a molten pool formed in a welding area using a laser welder (LW) in a welding process of a battery assembly process, as illustrated in FIG. 1. In addition, it may be an electrode or electrode material transported in a roll-to-roll manner during a battery electrode process, and may be a slurry coated on an electrode material transported in a roll-to-roll manner.

According to the real-time quality inspection method according to the present disclosure, the target object 1 may be photographed through a camera 100 in a high-speed environment in which the high-speed process is performed, thereby obtaining a large number of images Im, and the obtained plural images Im may be generated as a merged image AIm in an inspection server 200 to be analyzed in real time through learning and calculation using artificial intelligence (AI), thereby inspecting the quality.

In the current manufacturing industry, including batteries, per-hour production volume has become a very important factor due to technological advancements, which is associated with the manufacturing time of the relevant process, called tack time, in which there is a continuous demand for reduction of such a tact time.

However, in the high-speed process described above, since most of them use general vision cameras, there is data that is not acquired between frames due to low frame per second (FPS), so that the real-time quality inspection has been difficult in the electrode process or laser welding process in the battery manufacturing process where high-speed operations are performed. In addition, the real-time quality inspection has been difficult due to the large amount of computational time and capacity load required due to the processing of a large amount of images.

In this regard, the real-time quality inspection method according to the present disclosure proposes a method capable of real-time inspection of the quality for a target object manufactured through a high-speed process by generating a merged image using artificial intelligence (AI) and reducing a computation time through computational processing using the same.

Referring to FIGS. 2 and 3, the real-time quality inspection method according to the present disclosure includes a step S200 of photographing, by a camera 100, a target object 1 in a manufacturing process to obtain plural images Im; a step S300 of receiving, by an inspection server 200, plural images Im and arranging the plural images Im into a two-dimensional matrix to generate a merged image Aim; and a step S400 of inputting, by the inspection server 200, the merged image AIm into a quality inspection model AIMo to evaluate the quality of the target object 1 based on result data output by the quality inspection model AIMo, in which the quality inspection model AIMo may be an artificial intelligence model learned to receive an image AIm obtained by merging the plural images Im and output result data indicating the quality of the target object 1 shown in the merged image AIm.

The camera may be a high-speed camera or an ultra-high-speed camera that satisfies the performance of 250 to 300,000 FPS. This allows to prevent data loss while increasing the yield of the acquired plural images Im, and solve the difficulty of real-time inspection due to low FPS.

The inspection server may include a central processing unit (CPU) and a graphics processing unit (GPU).

The step S300 of receiving plural images Im and arranging the plural images Im into a two-dimensional matrix to generate a merged image AIm may be implemented through an image receiving unit 210 and an image merging unit 220 of the inspection server 200.

The step S400 of inputting the merged image AIm into the quality inspection model AIMo to evaluate the quality of the target object based on result data output by the quality inspection model AIMo may be implemented through a quality inspection unit 260 of the inspection server 200.

The step S200 of acquiring plural images Im may acquire any plural images Im from: plural images that are continuously photographed in real time by the camera 100 to capture a molten pool generated during the welding process of the target object 1 to indicate changes in the molten pool; plural images that are continuously photographed in real time by the camera 100 during the roll-to-roll transfer process of the target object 1 to indicate surface cracks or foreign matter attachment generated in the target object in the transfer process; and plural images that are continuously photographed in real time by the camera 100 to capture coating slurry generated in the process of coating the target object 1 to indicate changes in the coating slurry.

The step S200 of acquiring plural images Im may be performed in more diverse ways, and it should be noted that the industrial field and the target object are not limited by the description described above.

As illustrated in FIG. 3, the step S300 of arranging plural images Im into a two-dimensional matrix to generate a merged image AIm may allow the inspection server 200 to merge plural images Im into an array of “m×n”.

The number of horizontal images and the number of vertical images of the two-dimensional matrix may be determined so that a ratio of the horizontal size to the vertical size of the merged image AIm is 1 or close to 1.

The inspection server 200 processes the image with a fixed size during AI learning, in which when the size is out of the range of the aspect ratio of the horizontal and vertical sizes, the image ratio may be broken or deformed, and the recognition rate of the image may be reduced. The two-dimensional matrix may provide an image format suitable for AI model learning by arranging the horizontal and vertical sizes of the merged image AIm so that the ratio is 1 or close to 1, thereby preventing asymmetry in the horizontal and vertical directions. In addition, when the size of the merged image AIm exceeds or falls below a certain pixel, it is possible to prevent data loss that may occur due to data modification, such as data being newly created or deleted, during the process of changing into a size suitable for the quality inspection model AIMo.

The suitable aspect ratio may vary depending on a type of AI model, characteristics of the target object's photographing image, and the quality inspection items. In such cases, the number of horizontal and vertical images in the matrix may be adjusted to match a ratio other than 1:1.

According to the step S300 of arranging plural images Im into a two-dimensional matrix to generate a merged image AIm, the inspection server 200 may perform a sequential generation operation of generating the merged image AIm when the number of plural images Im received in real time from the camera 100 by the inspection server 200 reaches the number of images included in the merged image AIm, or a simultaneous generation operation of generating the multiple merged images AIm when all of the plural images Im received in real time from the camera 100 for a single target object 1 are received.

In the step S300 of arranging plural images Im into a two-dimensional matrix to generate a merged image AIm, a total of “K” merged images merged into an “m×n” array may be processed in batch units. Herein, considering the speed at which the high-speed process is performed and the hardware environment of the inspection server 200, the merged image AIm may be generated in such a manner as to batch-process plural images Im or sequentially process them.

In the case of batch-processing the plural images Im, when a total number of the plural images Im is “L”, the total number of “L” images may be batch-processed to generate a number of merged images AIm equal to the quotient of “L/K”. Herein, as shown in FIG. 3, the remaining images may be used to generate one additional merged image by adding a dummy image Dim.

In the case of sequentially processing the plural images Im, when a total number of plural images Im is “L”, the merged images AIm may be generated one at a time by sequentially arranging “m×n”, and such a process may be repeated. Herein, as shown in FIG. 3, the remaining images may be used to generate one additional merged image by adding a dummy image DIm.

Upon batch-processing the plural images Im or sequentially processing them, when the number of plural images Im is insufficient to generate the merged image AIm, the merged image may be generated by adding as many dummy images DIm as the insufficient number.

A dummy image DIm is an image that is randomly generated and added to ensure uniformity in the size of the merged image AIm, to allow the artificial intelligence to recognize a image format set in the inspection server 200 by filling in empty spaces of the merged image.

Since the plural images Im acquired with high FPS through the camera 100 is large in quantity, the computation time and load increase due to excessive input data when performing calculations using artificial intelligence in the inspection server 200. Herein, since the plural images Im are arranged in a two-dimensional matrix to generate a merged image AIm, the computation time and load for image inspection in the inspection server 200 are reduced, and high-speed image processing is enabled.

In the inspection server 200, the images are input in size of a single batch and processed once by the artificial intelligence. As shown in FIG. 3, a total of “K” merged images AIm merged into an “m×n” array are input as a batch unit, thereby reducing the number of operations processed by the artificial intelligence and enabling reduction of the total operation time due to processing a large number of images.

Therefore, in the step S300 of arranging plural images Im into a two-dimensional matrix to generate a merged image AIm, the merged image AIm is generated by arranging plural images Im into a two-dimensional matrix, and a large number of plural images Im received through a camera 100 may be calculated at high speed by the inspection server 200 using artificial intelligence (AI) by inputting a batch image Ba in which multiple merged images AIm are grouped into a batch unit, thereby allowing for real-time inspection.

In addition, when the inspection server 200 receives plural images Im from the camera 100, the processing time may be shortened by performing multiple processing using the multi-thread processing of a central processing unit (CPU).

In addition, when the inspection server 200 arranges the plural images Im into a two-dimensional matrix to merge them, the processing time may be shortened by performing multiple processing using the multi-thread processing of the central processing unit (CPU).

Meanwhile, in the step S300 of arranging plural images Im into a two-dimensional matrix to generate a merged image AIm, when there is a damaged image among the plural images Im, since quality inspection is impossible due to the damaged image, the inspection server 200 may post-process the data through statistical processing using machine learning, deep learning, convolutional neural network, etc. When the damaged image is recovered through data post-processing, it may be used to generate a merged image AIm, and when the damaged image is not recovered, it may be discarded. Statistical processing may include, for example, an average method or an interpolation method, and use normal data before and after the damaged image may be used.

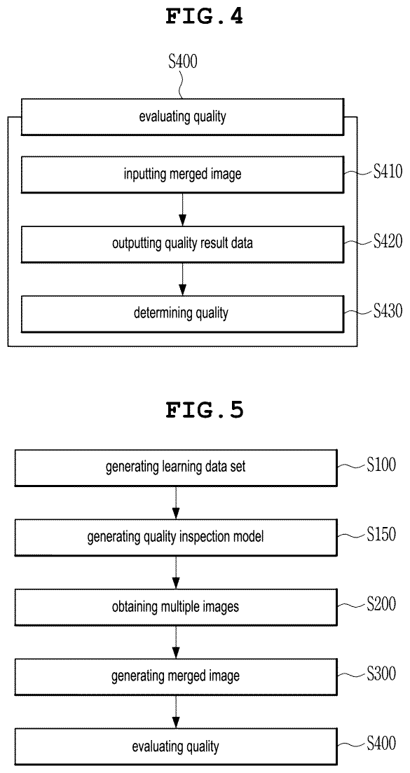

FIG. 4 is a detailed diagram showing a quality evaluation step in a real-time quality inspection method, according to an embodiment.

Referring to FIG. 4, in the real-time quality inspection method according to the present disclosure, the step S400 of evaluating the quality of the target object may include a step S410 of inputting, by an inspection server 200, a merged image AIm into a quality inspection model AIMo, a step S420 of outputting, by the inspection server 200, result data indicating the quality of a target object 1 based on information learned by the quality inspection model AIMo, and a step S430 of determining, by the inspection server 200, the quality of the target object 1 based on the result data.

The step S410 of the inspection server 200 inputting the merged image AIm into the quality inspection model AIMo is a step of inputting the merged image AIm into the quality inspection model AIMo, to inspect the quality of the target object 1 from the merged image AIm generated through the above-described step S300 of arranging the plural images Im into the two-dimensional matrix to generate the merged image AIm.

As described above, the quality inspection model AIMo may be an artificial intelligence model learned to receive an image AIm in which the plural images Im are merged, and output result data indicating the quality of the target object appearing in the merged image AIm.

The step S420 of outputting, by the inspection server 200, the result data indicating the quality of the target object 1 based on information learned by the quality inspection model AIMo is a step in which object detection, segmentation, classification, anomaly detection, etc. are performed on the merged image AIm using the learned quality inspection model AIMo to output the result data indicating the quality of the target object 1.

The result data may be location data of a molten pool area or location data of a welding crack generated during the welding process in the manufacture of a battery, location data of a surface crack or foreign matter that may be generated in the target object during the roll-to-roll transport process for the target object 1, or location data of a crack in a coating slurry that may be generated during the coating process of the target object.

The result data may be saved as a comma separated values (CSV) file, in which the CSV file is data with values separated by commas and may be used in Excel.

Only the result data is saved in a CSV file format, and the plural images Im and the merged images AIm may not be saved. There are problems that it takes a long time to save the plural images Im and the merged images AIm due to their sizes, and especially, the merged image (AIm) is tens of megabytes (Mb) in size per sheet, which causes a load on the image storage time. Therefore, by processing only the result data directly into a CSV file, the quality inspection of the target object may be quickly performed and the quality may be inspected in real time.

The inspection server 200 may replace the result data that is not inferred due to a damaged image with data that has undergone statistical processing using normal data before and after the damaged image.

The step S430 of determining, by the inspection server 200, the quality of the target object 1 is a step in which the quality of the target object 1 is determined based on the output result data using the learned quality inspection model AIMo.

For example, the welding quality may be determined using correlation with the penetration depth when the camera detects the area of the molten pool generated during the welding process in the battery manufacturing process, the electrode quality may be determined when detecting surface cracks or foreign substances that may occur on the electrode during the roll-to-roll transport process in the battery manufacturing process, and the slurry coating quality may be determined when detecting cracks that may occur during the slurry coating process in the battery manufacturing process.

Therefore, according to this disclosure, the merged image AIm is input into the quality inspection model AIMo which is learned artificial intelligence model to output the inferred result data, and the quality of the target object 1 is determined based on such result data, thereby analyzing the change trend in the target object 1 manufactured by the high-speed process. A step of utilizing the obtained analysis data of the target object 1 for quality improvement may be performed.

In addition, when the quality of the target object 1 is judged to be poor based on the result data, a step of separating the target object 1 judged to be poor may be included.

FIG. 5 is a diagram showing a real-time quality inspection method which further includes a learning data set creation step and a quality inspection model creation step, according to an embodiment.

Referring to FIG. 5, the real-time quality inspection method according to the present disclosure may further include a step S100 of generating learning data set that includes learning data including a merged image AIm obtained by arranging plural images Im obtained by photographing a target object 1 in a manufacturing process into a two-dimensional matrix, and label data including data indicating the quality of the target object, and a step S150 of inputting the learning data into an artificial intelligence model and comparing result data output by the artificial intelligence model with the label data to optimize the weight of the artificial intelligence model and create a quality inspection model AIMo.

The step S100 of generating the learning data set may be implemented through a learning data set generation unit 230 of the inspection server 200.

The step S150 of creating a quality inspection model may be implemented through a model generation unit 240 of the inspection server 200.

The step S100 of generating the learning data set and the step S150 of creating the quality inspection model are steps performed by the inspection server, in which the quality inspection model AIMo is created for use in quality inspection of the target object using the merged image AIm, and the weights of the artificial intelligence model may be optimized to minimize the loss function.

Gradient descent and backpropagation may be used to minimize the loss function. Gradient descent is a neural network learning algorithm that calculates the gradient of the loss function and updates the weights. Backpropagation is a neural network learning algorithm that adjusts parameters such as weights and biases by using the loss caused by the difference between the output calculated in forward propagation and the actual correct answer.

Learning data is data learned by AI using a merged image Aim obtained by arranging the plural images Im into a two-dimensional matrix.

Label data is the same data as data output by the AI model, which may be in the same form as the result data.

The step S100 of generating the learning data set and the step S150 of creating the quality inspection model are performed, and the quality assessment described above is performed using the created quality inspection model.

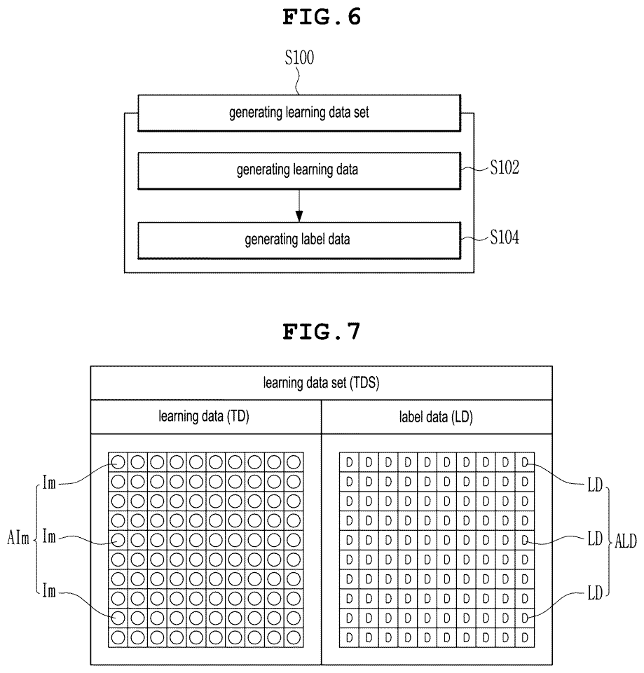

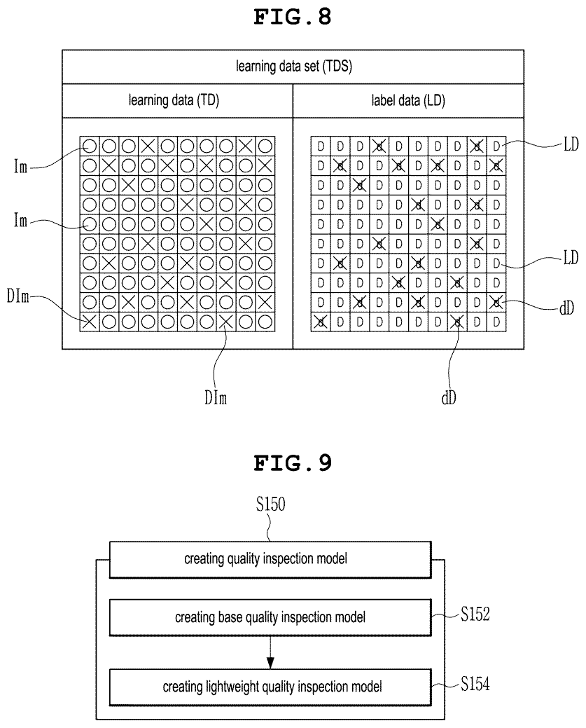

FIG. 6 is a detailed diagram showing a learning data set generation step in a real-time quality inspection method, according to an embodiment; FIG. 7 is a diagram showing an example of generating learning data and label data, in a real-time quality inspection method, according to an embodiment; and FIG. 8 is a diagram showing an example in which a dummy image is used for learning data having a merged image and dummy data is used for merged label data in a real-time quality inspection method, according to an embodiment.

As illustrated in FIG. 6, the step S100 of generating a learning data set in the real-time quality inspection method according to the present disclosure may include a step S102 of generating learning data including a merged image obtained by arranging plural images Im of a target object photographed during a manufacturing process into a two-dimensional matrix, and a step S104) of arranging data indicating the quality of the target object assigned to each of plural images Im of a target object taken during a manufacturing process into the same two-dimensional matrix as the merged image AIm to generate the merged label data.

In the step S102 of generating the learning data, plural images Im of the target object 1 are arranged into a two-dimensional matrix of “m×n” to generate the merged image AIm. The merged image AIm may be generated by arranging the plural images Im into a two-dimensional matrix of “m×n”, with a dummy image.

In the step S102 of generating the learning data, the plural images of the target object are arranged in a two-dimensional matrix of “m×n” to be merged, and a total of “K” merged images may be generated by merging them in an “m×n” array.

The learning data may be grouped into batch units.

The label data may also be used together to merge the plural images Im in the step S300 of generating a merged image AIm. Since the learning data is the image AIm in which plural images Im are merged, the label data may also be merged to correspond to the corresponding two-dimensional matrix, thereby generating a single merged label data.

FIG. 7 shows an example of generating label data LD having learning data TD with a merged image AIm and merged label data ALD in a real-time quality inspection method according to an embodiment.

Referring to FIG. 7, the learning data set TDS includes the learning data TD and the label data LD.

The learning data TD is configured in such a manner as to arrange the plural images Im into a two-dimensional matrix of “m×n” to form the merged image AIm.

The label data LD is configured in such a manner as to arrange data indicating the quality of the target object given to each of the plural images Im of the target object in the manufacturing process into the same two-dimensional matrix as the merged image AIm to form the merged label data ALD.

Referring to FIG. 8, the step S102 of generating learning data generates the merged image AIm by including dummy images DIm in the plural images Im of the target object in the manufacturing process in random number and location, and the step of generating label data S104 generates the merged label data ALD by positioning dummy data dD that is not associated with quality-indicating data at a location corresponding to the dummy images DIm included in the merged image AIm.

In the step S102 of generating learning data, when the number of plural images Im is insufficient to generate the merged image AIm, the insufficient number of dummy images DIm are added to generate the merged image AIm.

The dummy image DIm is an image that is randomly generated and added to ensure uniformity in the size of the merged image AIm, and an image that allows the AI to recognize the image format set in the inspection server 200 by filling in empty spaces of the merged image. When the merged image AIm including the dummy image DIm is learned, overfitting of the AI model may be prevented.

The dummy image DIm may be an image of a shape that is not associated with the target object 1 or an image of a single color. The dummy image DIm may be a black and white image.

The dummy image DIm may be created and filled by the inspection server 200 as many spaces as missing when merging images into an “m×n” array.

In addition, dummy data dD is not associated with the label data (LD), and the inspection server 200 may create and fill in the missing columns when merging data in an “m×n” array.

FIG. 9 is a detailed drawing showing the quality inspection model creation step in a real-time quality inspection method, according to an embodiment.

As illustrated in FIG. 9, in the real-time quality inspection method according to the present disclosure, the step S150 of creating a quality inspection model may include a step S152 of inputting learning data TD into an artificial intelligence model, comparing the result data output by the artificial intelligence model with label data LD, and performing learning to adjust a function of the artificial intelligence model to create a base quality inspection model, and a step S154 of optimizing the base quality inspection model using a lightweight engine to create a lightweight quality inspection model.

The step S152 of creating a base quality inspection model may be implemented through the model generation unit 240 of the inspection server 200.

The step S154 of creating the lightweight quality inspection model may be implemented through the model lightweight unit 260 of the inspection server 200.

In the step S152 of creating a base quality inspection model, learning to adjust a function of the artificial intelligence model may utilize backpropagation among neural network learning algorithms.

In the step S152 of creating a base quality inspection model, any one selected from deep learning models of mask regions with convolutional neural network (R-CNN), fast R-CNN, Yolo, and U-net may be used.

The base quality inspection model requires a relatively large model capacity and a lot of computing power for high performance, as an optimal quality inspection model created through neural network learning, so that lightweight processing is required to reduce the capacity in order to improve the performance according to real-time quality inspection.

In the step S154 of creating the lightweight quality inspection model, the lightweight quality inspection model may be generated by optimizing a base quality inspection model through methods such as quantization, fusion layer, model pruning, factorization, and distillation.

In the step S154 of creating the lightweight quality inspection model, the quality inspection time may be reduced while maintaining the performance in the inspection through artificial intelligence inference using the lightweight quality inspection model, and the minimum performance requirements for the hardware of the inspection server may be lowered by reducing the capacity of the quality inspection model.

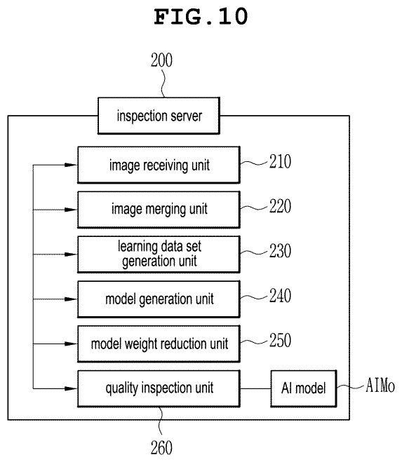

FIG. 1 is a diagram showing the configuration of an apparatus used in a real-time quality inspection method according to an embodiment; and FIG. 10 is a detailed configuration diagram showing an inspection server in a real-time quality inspection apparatus according to an embodiment.

Referring to FIG. 1 and FIG. 10, a real-time quality inspection apparatus according to an aspect of the present disclosure includes: a camera 100 that photographs a target object 1 in a manufacturing process to obtain plural images Im, and an inspection server 200 that receives plural images Im from the camera 100 and analyzes the plural images Im to inspect the quality, in which the inspection server 200 includes an image receiving unit 210 that receives plural images Im from the camera 100, an image merging unit 220 that arranges plural images Im into a two-dimensional matrix to generate a merged image AIm, and a quality inspection unit 260 that inputs the merged image AIm into a quality inspection model AIMo to evaluate the quality of the target object 1 based on result data output by the quality inspection model AIMo, and the quality inspection model AIMo may be an artificial intelligence model learned to receive an image AIm into which plural images Im are merged and output result data indicating the quality of the target object that appears in the merged image AIm.

The camera 100 may be a high-speed camera or an ultra-high-speed camera.

The camera 100 satisfies the performance of 250 to 300,000 FPS, in which the target object may be an object having a moving speed range of 100 mm to 100,000 mm per second based on the moving distance, or a result produced by the object.

The image acquired through the camera 100 may have a size of 256 pixels×256 pixels of RGB.

As the camera 100, a high-speed camera or an ultra-high-speed camera may be used to allow it to respond to a high-speed process, and may be a medium that enables real-time quality inspection for the target object manufactured through the high-speed process.

Considering why to use the high-speed camera or ultra-high-speed camera, for example in the battery manufacturing process, the laser welding machine's movement speed is more than 100 mm per second is performed in the laser welding of the battery assembly process, and the electrode's movement speed using a roller is about 100 m per minute in the battery electrode process.

There was a disadvantage that quality inspection may be performed only after completion of welding due to limitations in sampling speed even in such a laser welding process of high-speed environment, and there was a disadvantage that data was lost due to gaps occurring between each data due to limitations in sampling speed when performing vision inspections below the high-speed camera in the electrode process of high-speed environment.

Accordingly, according to the present disclosure, data loss due to sampling speed in a high-speed environment of a battery electrode process may be minimized and a full inspection of the entire electrode may be performed, by using a high-speed camera or an ultra-high-speed camera that satisfies the performance of 250 to 300,000 FPS. In addition, the basis may be established for performing not only post-welding inspection but also intermediate inspection in the laser welding process.

As illustrated in FIG. 10, the inspection server 200 of the real-time quality inspection apparatus according to the present disclosure may further include a learning data set generation unit 230 that generates a learning data set TDS including a learning data TD that includes a merged image AIm by arranging plural images Im of a target object 1 taken during a manufacturing process into a two-dimensional matrix, and a label data LD that includes data indicating the quality of the target object 1; a model generation unit 240 that inputs the learning data TD into an artificial intelligence model, compares result data output by the artificial intelligence model with the label data LD, and optimizes the weight of the artificial intelligence model to generate a quality inspection model AIMo; and a model weight reduction unit 250 that reduces the capacity of the quality inspection model AIMo.

The central processing unit of the inspection server 200 may execute a program code written to perform a real-time quality inspection method according to one embodiment, to implement the image receiving unit 210, the image merging unit 220, and the learning data set generation unit 230.

The graphic processing unit (GPU) of the inspection server 200 may execute a program code written to perform a real-time quality inspection method according to an embodiment, to implement the model generation unit 240, the model lightweight unit 250, and the quality inspection unit 260.

The image merging unit 220 performs a function of arranging plural images Im into a two-dimensional matrix to generate a merged image AIm, in which a form of merging the plural images Im into an “m×n” array may be applied as described above.

The learning data set generation unit 230 and the model generation unit 240 may use a PyTorch model, which is a deep learning framework.

The model lightweight unit 250 may use a Tensor RT engine and may optimize and lighten the quality inspection model AIMo generated from the model generation unit 240.

The quality inspection unit 260 may include an artificial intelligence model. The artificial intelligence model may be a quality inspection model.

The quality inspection unit 260 may analyze the merged image of the target object 1 in real time using the quality inspection model that is learned and lightweight.

Accordingly, in the present disclosure, it is possible to inspect the quality in real time for the target object 1 manufactured in a high-speed process using only a camera 100 and an inspection server 200.

In particular, the melt pool behavior, penetration depth, or presence of welding cracks may be inspected in the battery welding process. In the battery manufacturing process, it is possible to inspect whether there are surface cracks or foreign matter attachment on electrodes or electrode materials transported in a roll-to-roll high-speed environment in the battery electrode process. In the coating process of the battery electrode process, the behavior or presence of cracks of the slurry coated on the electrode material may be inspected.

Table 1 below shows image analysis results of the examples and comparative examples for the application of the merged image AIm in the real-time quality inspection method according to an embodiment.

Examples 1 and 2 and Comparative Examples 1 and 2 were tested by the inspection server on the basis of 400 sheets of images Im acquired by photographing the target object with a high-speed process from the camera.

The inspection server used Intel Xeon Gold 5215 as CPU, NVDIA RTX A6000 48 GB as GPU, and 512 GB as RAM. Mask R-CNN was applied as an artificial intelligence model, and Tensor RT was applied as a lightweight engine.

The size of each sheet of image was 256 pixels×256 pixels RGB.

Example 1, Example 2, Comparative Example 1, and Comparative Example 2 were all tested using the same test server and ultra-high-speed camera.

### EXAMPLE 1

The inspection server arranged the target object images acquired from the camera into a “10×10” array to generate a total 4 sheet of merged images AIm, and they were entered in batch units when inputting them into the quality inspection model. When the number of images per batch was called a batch size, the batch size was set to “1” and the number of operations for inspection was set to 4.

### EXAMPLE 2

The inspection server arranged the target object images acquired from the camera into a “10×10” array to generate a total of 4 merged images AIm, and they were entered as batch units when entering them into the quality inspection model. The batch size was set to “4” and the number of operations for inspection was set to 1.

### COMPARATIVE EXAMPLE 1

As a comparative example to compare with Examples 1 and 2, a single-sheet inspection was performed without merging images of the target object based on a total of 400 sheets, and one sheet of image was entered into the quality inspection model as a batch unit. The batch size was set to “1” and the number of operations for inspection was set to 400.

### COMPARATIVE EXAMPLE 2

As a comparative example to compare with Examples 1 and 2, 100 sheets of images were entered into the quality inspection model in batch units without merging images of the target object based on a total of 400 sheets. The batch size was set to “100” and the number of operations for inspection was set to 4.

TABLE 1
Data based on images of 400 sheets

| | | Whether | | | | Total | |
|---|---|---|---|---|---|---|---|
| | Batch | to merge | Number of | CPU | | operation | |
| classification | size | images | operations | usages | | time | |
| Comparative | 1 | X | 400 | 1.4 | GB | 15.31 | seconds |
| Example 1 | | | | | | | |
| Comparative | 100 | X | 4 | 1.32 | GB | 4.50 | seconds |
| Example 2 | | | | | | | |
| Example 1 | 1 | ◯ | 4 | 1.3 | GB | 0.93 | seconds |
| Example 2 | 4 | ◯ | 1 | 1.7 | GB | 0.52 | seconds |

Table 1 shows GPU usage and total operation time for each of Example 1, Example 2, Comparative Example 1, and Comparative Example 2, in which the total operation time means “image merging time+quality inspection time.”

Considering data shown in Table 1, it may be confirmed that Examples 1 and 2 that us the merged image AIm have significantly shortened total operation time compared to Comparative Examples 1 and 2 that do not use the merged image AIm, and Examples 1 and 2 show lower usage than Comparative Examples 1 and 2 with respect to CPU usage for processing images in batch units.

Therefore, according to the present disclosure having the technical configuration described above, it is confirmed that the real-time quality inspection method and apparatus allow the quality of the target object manufactured through a high-speed process to be inspected in real time by acquiring the image of the target object 1 in the high-speed process through the camera 100 and merging the image of the target object 1 in the inspection server 200 to utilizing it for quality inspection. It is possible to reduce the time that it takes to inspect the quality for the target object manufactured through a high-speed process could be reduced. Since the merged image AIm and the lightweight model, the memory usage of the graphic processing unit could be reduced while reducing power consumption.

The present disclosure has been described in detail through specific examples. The contents described above are merely examples of applying the principles of the present disclosure, and other configurations may be further included or replaced with other components without departing from the scope of the present disclosure.

What is claimed is:

1. A real-time quality inspection method, comprising
photographing, by a camera, a target object in a manufacturing process to acquire plural images;
receiving, by an inspection server, the plural images and arranging the plural images into a two-dimensional matrix to generate a merged image; and
inputting, by the inspection server, the merged image into a quality inspection model to evaluate a quality of the target object based on result data output by the quality inspection model,
wherein the quality inspection model is an artificial intelligence model that is learned to input an image in which the plural images are merged and output result data indicating the quality of the target object appearing in the merged image.

2. The method of claim 1, wherein the acquiring of the plural images comprises acquiring any plural images from:
plural images that are continuously taken in real time by the camera to photograph a molten pool generated during a welding process of the target object to indicate changes in the molten pool;
plural images that are continuously photographed in real time by the camera during a roll-to-roll transfer process of the target object to indicate surface cracks or foreign matter attachment generated in the target object in the transfer process; and
plural images that are continuously photographed in real time by the camera to capture coating slurry generated during a process of coating the target object to indicate changes in the coating slurry.

3. The method of claim 1, wherein the two-dimensional matrix has a number of horizontal images and a number of vertical images determined so that a ratio of a horizontal size to a vertical size of the merged image is 1 or close to 1.

4. The method of claim 1, wherein the generating of the merged image comprises performing a sequential generation operation of generating the merged image when a number of plural images received in real time from the camera by the inspection server reaches a number of images included in the merged image, or a simultaneous generation operation of generating multiple merged images when plural images received in real time from the camera for a single target object are all received.

5. The method of claim 1, wherein the generating of the merged image comprise generating the merged image by adding dummy images as many as insufficient number when a number of plural images received in real time from the camera is insufficient to generate the merged image.

6. The method of claim 1, wherein the evaluating of the quality of the target object comprises:
inputting, by the inspection server, the image merged into the quality inspection model;
outputting, by the inspection server, the result data indicating the quality of the target object based on information learned by the quality inspection model; and
determining, by the inspection server, the quality of the target object based on the result data indicating the quality of the target object.

7. The method of claim 1, further comprising:
generating a learning data set that includes learning data including the merged image obtained by arranging the plural images of a target object photographed in a manufacturing process into a two-dimensional matrix, and label data including data indicating the quality of the target object; and
inputting the learning data into an artificial intelligence model and comparing result data output by the artificial intelligence model with the label data, to optimize a weight of the artificial intelligence model and generate the quality inspection model.

8. The method of claim 7, wherein the generating of the learning data set comprises:
generating the learning data including the merged image by arranging the plural images of the target object photographed in the manufacturing process into a two-dimensional matrix; and
generating merged label data by arranging the data indicating the quality of the target object given to each of the plural images of the target object photographed in the manufacturing process into the same two-dimensional matrix as the merged image.

9. The method of claim 8, wherein the generating of the learning data comprises merging the photographed plural images of the target object by arranging them into a two-dimensional matrix of “m×n” and generating a total of “K” merged images merged into an “m×n” array.

10. The method of claim 8, wherein the generating of the learning data comprise generating the merged image by including dummy images in a random number and location in the plural images of the target object photographed in the manufacturing process, and
the generating of the label data comprises generating the merged label data by positioning dummy data not associated with the data indicating the quality at a location corresponding to the dummy images included in the merged image.

11. The method of claim 7, wherein the generating of the quality inspection model comprises:
inputting the learning data into an artificial intelligence model, comparing result data output by the artificial intelligence model with the label data, and performing learning to adjust a function of the artificial intelligence model to create a base quality inspection model; and
optimizing the base quality inspection model using a lightweight engine to generate a lightweight quality inspection model.

12. A real-time quality inspection apparatus, comprising
a camera obtaining plural images by photographing a target object in a manufacturing process; and
an inspection server receiving the plural images from the camera and inspecting a quality by analyzing the plural images,
wherein the inspection server comprises:
an image receiving unit receiving the plural images from the camera;
an image merging unit arranging the plural images into a two-dimensional matrix to generate a merged image; and
a quality inspection unit inputting the merged image into a quality inspection model to evaluate a quality of the target object based on result data output by the quality inspection model; and
wherein the quality inspection model is an artificial intelligence model which is learned to receive an image into which the plural images are merged and output result data indicating the quality of the target object appearing in the merged image.

13. The apparatus of claim 12, wherein the inspection server further comprises:
a learning data set generation unit generating a learning data set that includes learning data including a merged image generated by arranging the plural images of the target object photographed in the manufacturing process into a two-dimensional matrix, and label data including data indicating the quality of the target object;
a model generation unit inputting the learning data into an artificial intelligence model, comparing result data output by the artificial intelligence model with the label data, and generating the quality inspection model by optimizing a weight of the artificial intelligence model; and
a model lightweight unit reducing a capacity of the quality inspection model.

14. The apparatus of claim 12, wherein the camera satisfies a performance of 250 to 300,000 Fame Per Second (FPS), and the target object is an object having a moving speed range of 100 mm to 100,000 mm per second based on a moving distance, or a result produced by the object.
